(19) United States
(12) Patent Application Publication
(10) Pub. No.: US 2025/0297899 A1
(43) Pub. Date: Sep. 25, 2025

(54) THERMALLY POWERED ELECTRONIC STIRRING STICK FOR HOT AND COLD BEVERAGES

(71) Applicant: Matthew Most, Summertown, TN (US)

(72) Inventor: Matthew Most, Summertown, TN (US)

(21) Appl. No.: 19/079,678

(22) Filed: Mar. 14, 2025

Related U.S. Application Data
(60) Provisional application No. 63/567,438, filed on Mar. 20, 2024.

(51) Int. Cl. G01K 7/22; A47J 43/27; G01K 1/024; G01K 1/08; G01K 3/00; G01K 3/14

(52) U.S. Cl. CPC G01K 7/22; A47J 43/27; G01K 1/024; G01K 1/08; G01K 3/005; G01K 3/14; A47J 2202/00

(57) ABSTRACT

A thermally powered electronic beverage monitoring device (e.g., stirring stick) that indicates beverage temperature, operating without the need for battery charging. The device integrates a thermoelectric generator to harvest energy from the temperature differential between the beverage and ambient air. Various embodiments provide temperature or other indications via LED indicators, LCD displays, wireless smartphone connectivity, or haptic and auditory alerts.

### CROSS REFERENCE

The present application claims the benefit of U.S. Provisional Patent Application No. 63/567,438 having a filing date of Mar. 20, 2024, the entire contents of which are incorporated herein by reference.

### FIELD

The present application relates to a beverage stirring stick that actively measures and indicates the temperature of a drink, utilizing thermoelectric energy harvesting for operation.

### BACKGROUND

Optimal consumption temperatures for beverages such as coffee, tea, hot chocolate, soda, and ice water often differ significantly from ambient temperature. As a result, there is a limited time window after serving during which a beverage remains at an ideal drinking temperature, before environmental heat transfer causes excessive cooling or warming. Additionally, hot beverages are often initially served at temperatures higher than what is safe for immediate consumption, requiring time for cooling before drinking. However, excessive cooling diminishes flavor perception and appeal. Conversely, for cold beverages, prolonged exposure to ambient conditions reduces their cooling effect and perceived refreshment. Because beverage temperature cannot be accurately determined by visual inspection or touch, individuals often rely on subjective judgment, increasing the risk of burns from excessively hot drinks or diminished enjoyment from overly cooled beverages. A device that provides real-time, objective temperature feedback could improve both safety and beverage enjoyment.

### SUMMARY

This disclosure presents a thermally powered electronic beverage monitoring device (e.g., stirring stick) that indicates beverage temperature, operating without the need for battery charging. The device integrates a thermoelectric generator to harvest energy from the temperature differential between the beverage and ambient air. Various embodiments provide temperature or other indications via LED indicators, LCD displays, wireless smartphone connectivity, or haptic and auditory alerts.

In the exemplary disclosed embodiments, the device is in the form of a beverage stirring stick and contains a thermoelectric generator for energy harvesting.

In one embodiment, a visual indication of drink temperature is provided in the form of an LED indicator.

In another embodiment, the device contains an accelerometer and a wireless radio which provides connectivity with a smartphone.

In another embodiment, the device contains electronics which produce audible or haptic indications such as beeps, tones or vibrations to indicate that the drink has reached a desired temperature.

Further features, advantages and properties of the device according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIG. 1 is a perspective view of a stirring stick in accordance with the disclosure, in an embodiment.

FIG. 2 is a perspective view of an embodiment of the stirring stick in a teacup,

FIG. 3 is a sectioned view of an embodiment of the stirring stick with an axial flow thermoelectric generator,

FIG. 4 is a sectioned view of an embodiment of the stirring stick with a transverse flow thermoelectric generator.

FIG. 5 is a perspective view of the thermoelectric generator soldered to a flexible printed wiring board, in an embodiment.

FIG. 6 is a simplified circuit diagram showing integration of a thermoelectric voltage source, a cold-start circuit, a power-conversion stage, a storage capacitor, a microcontroller, a temperature sensor, an LED indicator and a magnetic field sensor, in an embodiment.

### DETAILED DESCRIPTION

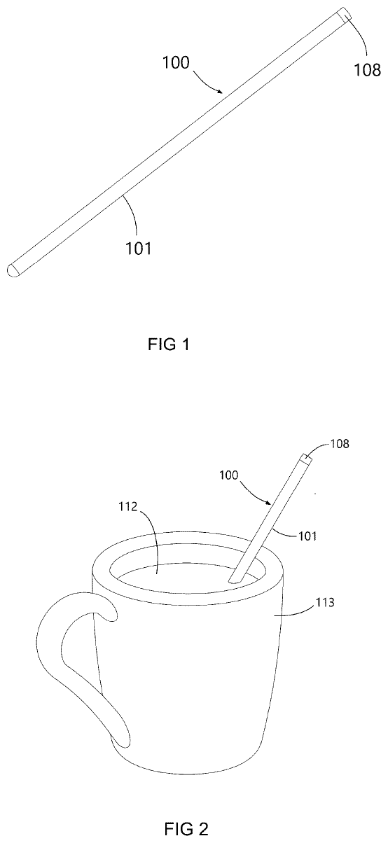

An embodiment of the present disclosure is a beverage temperature monitoring device. The device is illustrated as a beverage stirring stick 100 illustrated in FIG. 1, in one embodiment. The stirring stick 100 is depicted in a teacup 113 in FIG. 2, and features an exterior housing 101 and an LED indicator 108. The stirring stick 100 is of sufficient length to protrude above the surface of the drink liquid 112 into the surrounding air. The stirring stick has a cross-sectional diameter between 2 and 12 millimeters, in an embodiment, and between 2 and 7 millimeters in another embodiment. The stirring stick has a length between 80 and 230 mm, in an embodiment.

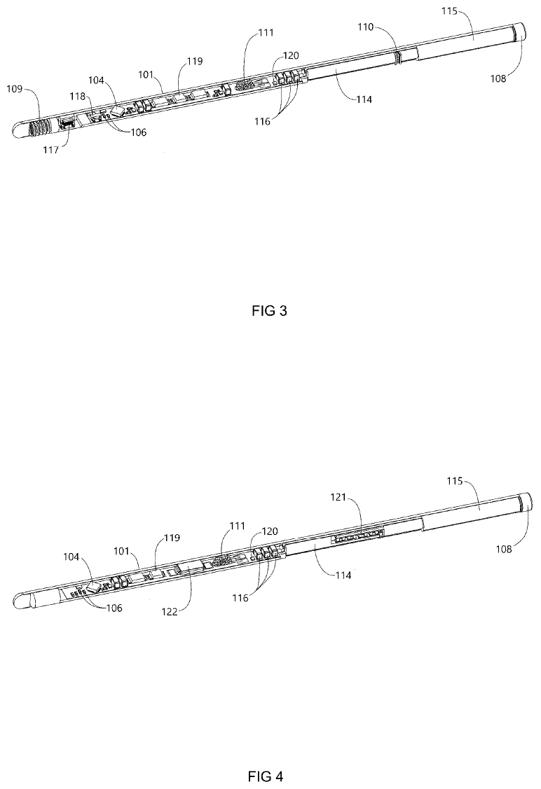

FIG. 3 shows a cutaway view of an embodiment of the stirring stick with an axial-flow thermoelectric generator 110. The thermoelectric generator 110 is sandwiched between two heat spreaders (e.g., thermally conductive elements), a lower heat spreader 114 and an upper heat spreader 115. The heat spreaders 114, 115 are made of highly thermally conductive material such as aluminum, copper, or ceramic. In one embodiment, the heat spreaders conduct heat to and from a thermoelectric generator consisting of bismuth-telluride thermocouple elements 123 depicted in FIG. 5. In this embodiment, the thermoelectric generator consists of 8 pairs of N-channel and P-channel type thermocouple elements 123 forming 8 distinct thermocouples connected in series, and soldered to an alumina ceramic substrate 124, as is typical in thermoelectric generator construction. In this embodiment, the thermocouple elements 123 are 0.5 mm in width, 0.5 mm in length, and 0.8 mm in height. A multitude of element configurations of varying sizes, numbers and wiring configurations are possible depending on voltage and power requirements, as well as specific geometrical and thermodynamic conditions. In typical thermoelectric generator design, thermocouple elements are soldered to alumina ceramic substrates on both hot and cold thermal interface planes. In the current embodiment, however, one alumina ceramic substrate is replaced with a flexible printed wiring board 125, which provides direct electrical connection between the thermocouple elements and the power-conversion circuitry. This simplifies device manufacture and reduces electrical interconnection losses. In one embodiment, a coil spring 109 provides axial clamping force to the thermoelectric generator 110 and heat spreaders 114 and 115, ensuring close mechanical coupling of these parts. This configuration results in a low thermal resistance pathway along the axis of the stirring stick 100, which passes through the thermoelectric generator 110. In the case of a hot beverage, this configuration draws heat from the beverage along the axis of the device to the exposed end, where it radiates, convects and conducts to the environment. This creates a temperature gradient across the thermoelectric generator 110, which generates electricity based on the temperature differential between the upper and lower heat spreaders. In heated beverages, the lower heat spreader 114 being disposed in or nearer to the heated fluid has a higher temperature (e.g., via conduction through the housing from the heated beverage) than the upper heat spreader resulting in the temperature gradient across the thermoelectric generator. In the case of a cold beverage, heat flows in the opposite direction from the environment to the beverage. In this embodiment the upper heat spreader 115 is warmer than the lower heat spreader 114, which is closer to the cooled liquid. Again, this results in a temperature gradient across the thermoelectric generator, which generates electricity by similar means.

The device described in the present embodiment is a space-constrained application, necessitating a thermoelectric generator with a limited number of thermocouple elements. This practically restricts the thermoelectric generator output (e.g., generator output voltage) to less than the voltage (e.g., working voltage) required to drive a conventional microprocessor. A voltage boost converter is therefore required to increase the generator output voltage to sufficient levels (e.g., a working voltage). In the current embodiment, a flyback boost converter consisting of a primary inductor 111, a diode 119, a transistor 120 and a microcontroller 104 multiply voltage from a range of 5-350 millivolts to a range of 0.5-5 volts. Capacitors 116 store energy for times of peak power demand, such as when flashing LEDs or transmitting wireless data packets. Other boost converter topologies such as charge pumps, joule thief circuits or transformer-based designs can also be used for voltage multiplication.

In one embodiment, incorporation of a thermoelectric generator allows for a completely battery free design. Since most boost converter topologies are driven by active microelectronics, a minimum voltage between 0.4 and 2 volts is required to begin converter operations. If the thermoelectric generator output (e.g., generator output voltage) cannot reach this voltage, the boost converter cannot start, and a cold-start circuit is needed to bootstrap device operation. One possible embodiment includes a transformer 117 and a depletion-mode MOSFET 118 which creates a passive oscillator capable of starting from 10 millivolts or even lower. This oscillator provides initial voltage multiplication, after which the main boost converter performs primary power conversion functions. Other self-starting oscillator topologies such as Hartley oscillators, Colpitts oscillators, ring oscillators and others can be applied for this purpose. Depending on device efficiency and power requirements, this self-starting oscillator can work alone as the primary boost converter, or be limited to usage as a cold-start circuit to bootstrap operation of a separate boost converter.

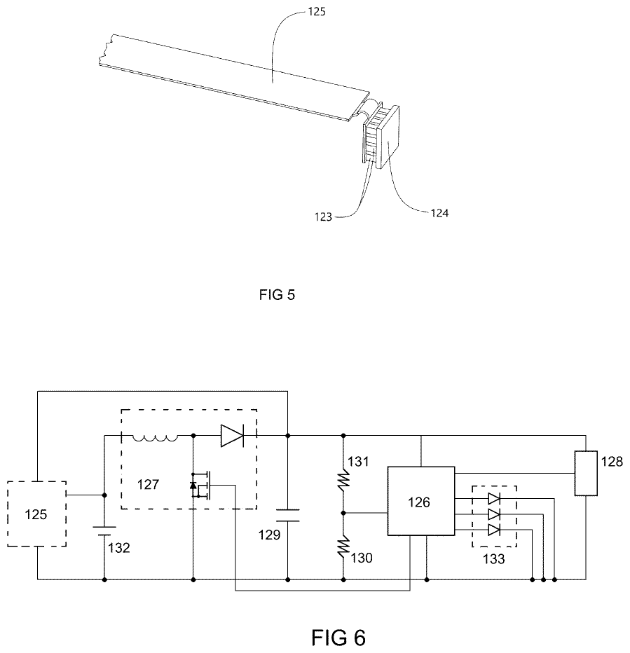

FIG. 6 depicts a simplified operating circuit consisting of a thermoelectric voltage source 132, a cold start circuit 125, a microcontroller 126, a flyback boost converter stage 127, a storage capacitor 129, a thermistor 131, a bias resistor 130, a tri-color LED module 133, and a magnetic field sensor 128. In this particular embodiment, power initially flows from the thermoelectric voltage source 132 (e.g., thermoelectric generator 110 and heat spreaders 114, 115 of FIG. 3) to the cold-start circuit 125 (e.g., transformer 117 and a depletion-mode MOSFET 118 of FIG. 3) and then to the storage capacitor 129 (e.g., capacitors 116 of FIG. 3). When the storage capacitor 129 has developed sufficient voltage to start the microcontroller 126 (e.g., microcontroller 104 of FIG. 3), the microcontroller 126 begins to actively drive the flyback boost converter stage 127, which in turn draws power from the thermoelectric voltage source 132 and provides it to the storage capacitor 129. A thermistor 131 together with a bias resistor 130 creates a voltage divider which provides a temperature-correlated analog signal to the microcontroller 126. The microcontroller 126 generates a control output based on a user set or preset temperature threshold. The control output is received by the indictor (e.g., LED module 133) which is activated in response to the control output.

In one embodiment, an optional magnetic field sensor 128 enables a user-interface for setting a customized notification temperature threshold. During device operation and when the desired notification temperature threshold has been reached, a magnet of sufficient strength can be placed near the device. This triggers the magnetic field sensor 128 to signal the microcontroller 126 to store the current measured temperature as the desired notification temperature threshold for future use. In another embodiments, the microcontroller 126 uses pre-programmed temperature ranges and/or a user-selected temperature(s) notification threshold to generate a control output to light certain colors of the tri-color LED module 133 as the beverage temperature passes through various temperature ranges of interest. Other notification mechanisms such as auditory and haptic transducers can be used in addition to or as an alternative to visual notification. If the device contains wireless connectivity, programming of the notification threshold can be achieved with a software application through a smartphone or tablet, as an alternative to the magnetic sensor. In this case, temperature-related notifications can be provided directly to the connected device without the use of direct visual, auditory or haptic notifications.

In a related embodiment, a device of similar construction contains a transverse-flow thermoelectric generator 121 depicted in FIG. 4. As an alternative to a cold-start oscillator, this embodiment contains a thermostatic switch 122 which opens at a specific temperature. This switching event interrupts supply current from the thermoelectric generator 121 which is passing through an inductor. This current interruption creates a voltage spike which provides the initial voltage to begin boost converter operations.

Integrated sensors 106 can provide information to the user such as beverage temperature, water purity, total dissolved solids concentration, or PH balance of the liquid. Onboard microelectronics can include one or more wireless radios to interface the device with a smartphone, tablet or PC. Data can be provided directly to the user through electronic smartphone notifications, or through LED or LCD indication, vibratory, haptic, or audible alerts from the device itself. An accelerometer can be used to monitor user interaction and detect when a drink has been forgotten to alert the user through one or more means.

Although the teachings of the present application have been described in detail for the purpose of illustration, it is understood that such detail is solely for that purpose, and variations can be made therein by those skilled in the art without departing from the scope of the teaching of this application. For example, the device has been described with a cylindrical housing, but it is understood that the housing could have any other suitable shape or cross-section.

Features described in the preceding description may be used in combinations other than the combinations explicitly described.

What is claimed:

1. A thermoelectric powered beverage temperature monitoring device, comprising:
an elongated housing having a maximum cross-dimension along a length axis of less than 10 mm;
a thermoelectric voltage source disposed within the elongated housing, wherein the thermoelectric voltage source generates a generator output voltage based on a temperature gradient along the elongated housing;
a voltage boost converter configured to receive the generator output voltage and amplify the generator output voltage to a working voltage;
a microcontroller powered by the working voltage and configured to:
determine a temperature at a location along the housing; and
upon identifying the temperature being associated with a threshold, generate a control output; and
an indicator in electrical communication with the microcontroller, wherein the indicator provides one of a visual, auditory or haptic output in response to receipt of the control output.

2. The device of claim 1, wherein the maximum cross-dimension is between 2 mm and 7 mm.

3. The device of claim 1, wherein the elongated housing is cylindrical over a majority of its length.

4. The device of claim 1, wherein the thermoelectric voltage source comprises a thermoelectric generator disposed between two thermally conductive elements disposed within the elongated housing.

5. The device of claim 4, wherein the thermoelectric generator comprises a plurality of thermocouples connected in series.

6. The device of claim 5, wherein at least a portion of the plurality of thermocouple elements are directly connected to a flexible printed wiring board including circuitry of the voltage boost converter.

7. The device of claim 1, wherein the voltage boost converter comprises a flyback boost converter.

8. The device of claim 1, further comprising at least one capacitor for storing electrical energy from at least one of the thermoelectric voltage source and the voltage boost converter.

9. The device of claim 8, wherein the microcontroller is configured to draw the electrical energy from at least one capacitor.

10. The device of claim 1, further comprising:
a cold-start circuit configured to receive the generator output voltage and provide initial voltage multiplication to the voltage boost circuit.

11. The device of claim 1, wherein the indicator comprises an LED, which provides a visual output upon receipt of the control output.

12. The device of claim 1, wherein the indicator comprises a plurality of LEDS, wherein different ones of the plurality of LEDS provide different visual outputs based on different temperatures determined by the microcontroller.

13. The device of claim 1, wherein the threshold is preset.

14. The device of claim 1, wherein the threshold is user selectable.

15. The device of claim 1, further comprising:
a thermistor configured to generate an analog signal indicative of a temperature at at least one location along a length of the elongated housing, wherein the analog signal is received by the microcontroller.

16. A method for monitoring the temperature of a beverage, comprising:
inserting a lower end of an elongated housing into a beverage having a temperature that is different than ambient temperature, wherein an upper end of the elongated housing extends above a surface of the beverage;
generating an electrical voltage in response to a temperature differential along a length of the elongated housing;
powering a microcontroller with the electrical voltage generated in response to the temperature differential, wherein the microcontroller is configured to identify a temperature associated with the beverage and generate a control output when the temperature meets at least one threshold; and
activating an indicator that provides one of a visual, auditory and haptic output in response to the control output from the microcontroller.

17. The method of claim 16, wherein generating the electrical voltage comprises:
operating a thermoelectric voltage source disposed within the elongated housing, wherein the thermoelectric voltage source generates a generator output voltage based on a temperature gradient along the elongated housing; and
boosting the generator output voltage using a voltage boost converter to generate a working voltage.

18. The method of claim 17, further comprising:
Initially operating a cold-start circuit configured to receive the generator output voltage and provide initial voltage multiplication to the voltage boost circuit.

19. The method of claim 16, wherein the indicator comprises an LED, wherein the activating the indicator comprises lighting the LED when the temperature meets a predetermined threshold.

20. The method of claim 19, wherein the indicator comprises a plurality of LEDs, wherein the activating the indicator comprises lighting individual ones of the plurality of LEDs at different temperatures.
